(19) United States
(12) Patent Application Publication
(10) Pub. No.: US 2006/0162138 A1
(43) Pub. Date: Jul. 27, 2006

(54) Hanger for rope or the like

(75) Inventor: Shigejiro Kimura, Hamamatsu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: KABUSHIKI KAISHA NIICHI, Shizuoka (JP); FUJIE BUSSAN KABUSHIKI KAISHA, Shizuoka (JP)

(21) Appl. No.: 10/522,780

(22) PCT Filed: Apr. 25, 2003
(86) PCT No.: PCT/JP03/05410

§ 371 Date: Feb. 1, 2005

(30) Foreign Application Priority Data
Aug. 2, 2002 (JP) 2002-225599
Feb. 6, 2003 (JP) 2003-29994

(51) Int. Cl. F16B 45/02

(52) U.S. Cl. 24/599.6

(57) ABSTRACT

A rope hook with an off-the-hook limiting lever connected to a lever support of a body to be able to pivot in a front to rear direction and to shift laterally within a predetermined range. The lever is urged frontward (in a closed direction) and leftward (in a locked direction) by a complex spring. In the locked condition, the lever is prevented from pivoting rearward (in an opened direction) by a stopper edge of the arm engaging with a stopper surface of the body. In this connection, when it is intended to release the locked condition, it is necessary to push the lever rightward to disengage the stopper edge with the stopper surface and then push the lever rearward to pivot it in the opened position. In other words, the lever remains unopened unless two forces perpendicular to each other are applied sequentially to the lever.

### BACKGROUND OF THE INVENTION

1. Technical Field

The present invention relates to a rope hook. More particularly, the invention relates to a rope hook including a body having rope catches of substantially hook shape for disconnectably receiving ropes and off-the-hook limiting levers pivotally connected to the body.

2. Description of the Prior Art

There are various kinds of slinging means such as hanging hooks and rope connectors used in the crane or the winch, and a hooked portion of the turnbackle. These slinging means and hanging hooks include in many cases one or more catching means of C or U shape to which a rope or a portion of the rope spliced into looped shape is to be threaded.

Some of these slinging means further include a off-the-hook limiting lever (referred simply as “a stop”, “a snap lever” or “a metal piece”).

An example of the rope hook (a) of the prior art including off-the-hook limiting lever will now be described with reference to FIG. 16.

The rope hook (a) is of a type used for many cranes or winches, and a disc shaped thick intermediate portion (b), a substantially inverted U shaped first catch (c) extending from the intermediate portion (b), and a hook shaped second catch (d) extending from the intermediate portion in an opposite direction. A rope (e) is threaded through the first catch (c) and spliced to form a loop, and a loop (f) of another rope is then hooked releasably to the second catch (d).

The second catch (d) is provided further with an off-the-hook limiting lever (h) for closing the opening (g) defined between the base and the tip of the catch. The lever (h) is of substantially inverted L shape and is pivotally connected at its shorter arm to the base of the hook (d) through a pin (i). The opening (g) is remained closed by urging the longer arm of the lever in counterclockwise direction in FIG. 16 by means of a torsion spring (j) mounted around the pin (i). Thus the opening (g) is left closed in which the tip of the lever (h) is urged on a inside surface of the hook (d), unless the lever is pivoted in clockwise direction against the action of the spring.

When it is intended to engage the loop (f) of the rope with the second catch (d), the lever (h) is pushed to be displaced inwardly to the position shown by the two-dot chain line to open the opening (g), the loop (f) is hooked on the catch, and then release the urging force applied on the lever (h) to return the lever to its closed position. Thus the disengagement of the loop (f) with the catch (d) cannot be achieved so long as the lever (h) is retained in its closed position.

In the rope hook (a), it scarcely occurred to unhook the loop (f) unless the lever (h) is urged intentionally in counterclockwise direction. However, unintentional unhooking of the lever can rarely be occurred. For example, in the case that the rope hook (a) is used to tow an automobile, there is a possibility to slack the rope strained substantially horizontally and strike the rope against the lever (h) to push it to open the opening. If the rope is made of steel wires, the rope can be sprung back to disengage the loop (f) from the catch (d). This can lead to an unexpected accident.

On the contrary, in the case of the shackle having an opening adapted to be closed by means of a pin threaded and screwed with the arms of the U shaped body of the shackle, the opening never opens. However it has another disadvantage that the engagement and disengagement of the ropes are cumbersome, because the screwing and the unscrewing operations are required therefor.

### SUMMARY OF THE INVENTION

The present invention is provided through taking the above-mentioned disadvantages of the rope hook of the prior art into consideration. Accordingly the object of the present invention is to provide a remarkably excellent rope hook, which is good at its safety and can be operated easily. The lever of the rope hook of the present invention remained unopened unless two forces perpendicular with each other are applied sequentially thereto.

These and other objects are achieved by a rope hook in accordance with a first invention comprising: a body including a pair of substantially hook shaped rope catches, a off-the-hook limiting lever pivotally connected at its base by means of a pivotal fulcrum to the body of the part other than the tip portion of the rope catch so as to pivot from a closed position in which the end portion of the lever bear against the inside surface of the tip to close the opening defined between the end portion and the tip to an open position in which the end portion is spaced from the tip, and a spring to urge the levers to pivot them to the closed position, characterized in that it further comprising: a spring for providing clearances allowing the lateral displacement of the levers in the direction perpendicular to the pivotal movement of the levers within the predetermined range and for urging the levers laterally to their locked position, and stopper means for preventing the pivotal movement of the levers toward the opened position only when the off-the-hook limiting levers are positioned in their locked position.

When it is intended to pivot the lever to the open position, it is necessary to urge the lever in the direction perpendicular to the pivoting direction to disengage the lever and then push the lever to the open position. In other words, the lever of the rope hook of the present invention remained unopened unless tow forces are applied sequentially from two directions perpendicular with each other. Such situation cannot be realized without any intentional support.

Thus unintentional displacement of the lever to the open position can be substantially avoided.

The lever can be made ready for pivoting to its open position only by pushing it to the lock-release position, since the stopper means for preventing the lever from moving toward the open position has such a structure that it can prevent the pivotal movement of the lever only when the lever is positioned in the locked position. In this connection, the hooking or unhook in operation can easily be made by simple action.

The rope hook of a second invention is that according to the first invention, wherein the stopper means includes a surface portion of the body defined beside a lever support to which the lever is to be pivotally connected at its base and a portion of the base of the lever.

Some kinds of stopper means can be occurred in the present invention, for example the pivotal movement of the lever can be prevented upon coming the lever into its locked position by any protuberances provided on the body of the rope hook. Whereas the structure defined in the second invention does not require adding any special member thereto.

The rope hook of a third invention is that according to the first invention, wherein the stopper means includes a locking claw formed on the tip of the rope catch and a locking protrusion formed on the end portion of the lever.

In such a structure, unintentional pivotal movement of the lever in its locked position can be prevented without any special member.

The rope hook of the fourth invention is that according to the third invention, wherein a predetermined amount of clearance or margin allowing the lateral swing of the lever to disengage the locking protrusion with the locking claw is provided at the pivotal fulcrum of the lever.

In such a structure, a strongly locked state can be maintained when the lever is in its locked position, and when it is intended to open the rope hook the locked state can be released only by slightly displacing the lever in the lateral direction so that the force required for this releasing operation is inconsiderable, and any additional space for sliding the lever is not necessary.

Upon making the present invention into practice, the rope hook may include two kinds of springs i.e. a spring for urging the lever into the closed position and a spring for urging the lever into the locked potion. Whereas, as defined in a fifth invention, the spring for urging the lever to the closed position and the spring for urging the lever to its locked position can be combined to form an integral spring. This leads to the reduction of the number of the parts and also reduce the man-days for assembling the rope hook.

An example of the form of such a combined spring is, as defined in a sixth invention, a complex one including coils and side arms extending from the end of each coils and made of one wire rod of spring material. The arms are served to urge the lever toward the closed position and the coils are served to urge the lever to the locked position.

The rope hook of a 7th invention is a rope hook comprising: a body including a pair of substantially hook shaped rope catches, a off-the-hook limiting lever pivotally connected at its base by means of a pivotal fulcrum to the body of the part other than the tip portion of the rope catch so as to pivot from a closed position in which the end portions of the lever bear against the inside surface of the tip to close the opening defined between the end portion and the tip to an open position in which the end portions are spaced from the tips, and a spring to urge the lever to pivot it to the closed position, characterized in that it further comprising: a spring for providing clearances allowing the displacement of the lever in the direction perpendicular to the pivotal movement of the lever within the predetermined range and for urging the lever laterally to their locked position, and stopper means for preventing the pivotal movement of the lever toward the opened position only when the off-the-hook limiting levers are positioned in their locked position.

The rope hook of an 8th invention is that according to the 7th invention, wherein the stopper means includes a locking claw formed on the tip of the rope catch and a locking protrusion formed on the end portion of the lever.

The rope hook of a 9th invention is that according to the 8th invention, wherein a predetermined amount of clearance or margin allowing the swing of the lever to disengage the locking protrusion with the locking claw is provided at the pivotal fulcrum of the lever.

The rope hook of a 10th invention is that according to any one of the 7th to 9th inventions, wherein the spring for urging the lever to the closed position and the spring for urging the lever to its locked position are combined to form an integral spring.

The rope hook of a 11th invention is that according to the 10th invention, wherein the spring including coils and side arms extending from the end of each coils is an complex spring made of one wire rod of spring material, the arms are served to urge the lever toward the closed position and the coils are served to urge the lever to the locked position.

The rope hook of a 12th invention is that according to the 11th invention, further comprising a means for compressing the coil of the spring to urge the lever to the locked position.

The rope hook of a 13th invention is that according to the 12th invention, wherein the means for compressing the coil is formed by an inclined portion provided in either of the body or the lever to which the coils are urged.

### BRIEF DESCRIPTION OF THE DRAWINGS

Further feature of the present invention will become apparent to those skilled in the art to which the present invention relates from reading the following specification with reference to the accompanying drawings, in which:

FIG. 1 is a perspective view showing the rope hook in accordance with the first embodiment of the present invention;

FIG. 2 is an exploded perspective view showing the rope hook of FIG. 1 from different direction;

FIG. 3 is a partially cross sectional view taken substantially along line A-A of FIG. 1;

FIG. 4 is a partially cross sectional view taken substantially along line B-B of FIG. 3 wherein the off-the hook limiting lever is in its locked position;

FIG. 5 is a partially cross sectional view taken substantially along line B-B of FIG. 3 wherein the off-the hook limiting lever is in its lock release position;

FIG. 6 is a perspective view showing the rope hook in accordance with the second embodiment of the present invention;

FIG. 7 is an exploded perspective view showing the rope hook of FIG. 6 wherein the off-the hook limiting lever is dismounted;

FIG. 8 is a side view showing the rope hook of FIG. 6 wherein the lever is shown in both of the opened and closed positions;

FIG. 9 (a) is a front view showing the rope hook of FIG. 6 in its closed position (locked position), FIG. 9 (b) is a front view showing the rope hook of FIG. 6 in its opened position in which the lever swings to disengage the locking protrusion with the locking claw, and FIG. 9 (c) is a bottom view showing the catch in which the locking claw is provided;

FIG. 10 is a front view showing the rope hook in accordance with the third embodiment of the present invention wherein the off-the hook limiting lever is locked;

FIG. 11 is an enlarged partially cross-sectional view of FIG. 10;

FIG. 12 is a front view showing the rope hook in accordance with the third embodiment of the present invention wherein the off-the hook limiting lever is disengaged;

FIG. 13 is an enlarged partially cross-sectional view of FIG. 12;

FIG. 14 is an enlarged partially cross-sectional view showing the rope hook in accordance with the fourth embodiment of the present invention wherein the off-the hook limiting lever is in its locked position;

FIG. 15 is an enlarged partially cross sectional view showing the rope hook in accordance with the fourth embodiment of the present invention wherein the off-the hook limiting lever is in its lock release position; and

FIG. 16 is a view showing an example of the rope hook of the prior art including the off-the hook limiting lever.

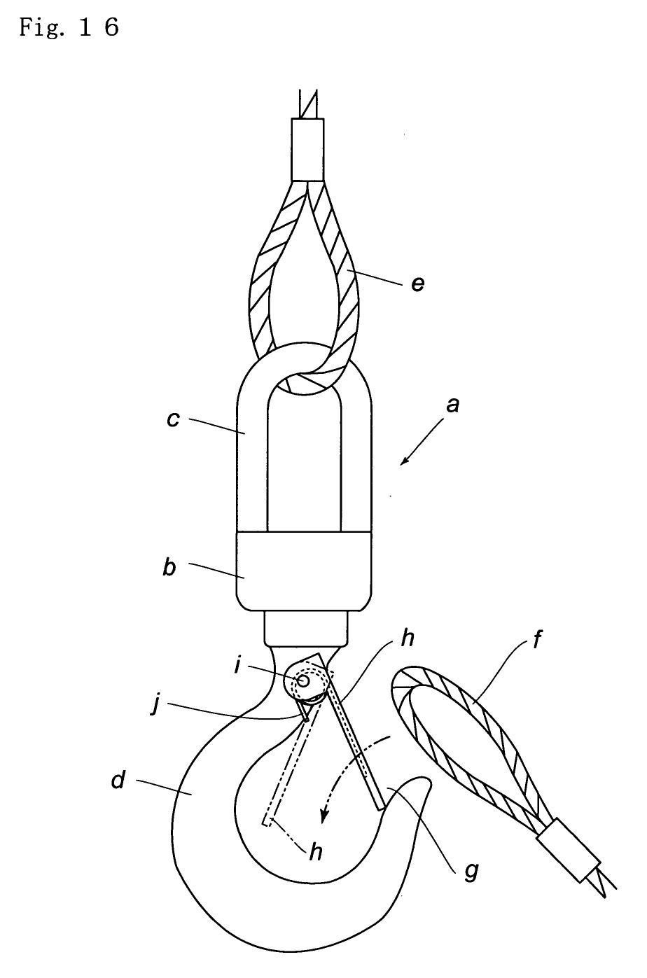

### DETAILED DESCRIPTION OF THE INVENTION

First to fourth embodiments of the rope hook 1 in accordance with the present invention will now be described in detail with reference to the attached drawings.

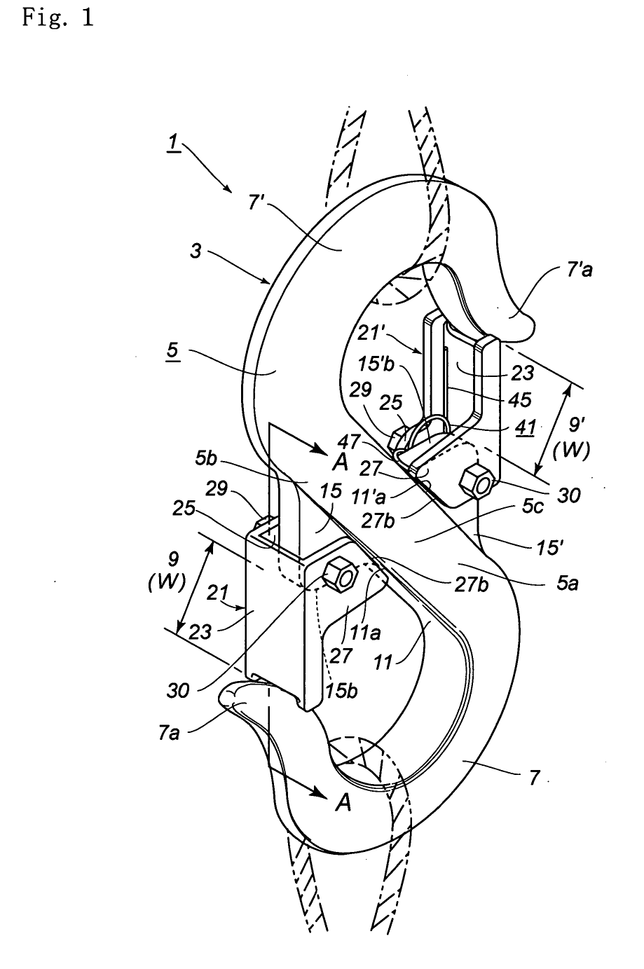

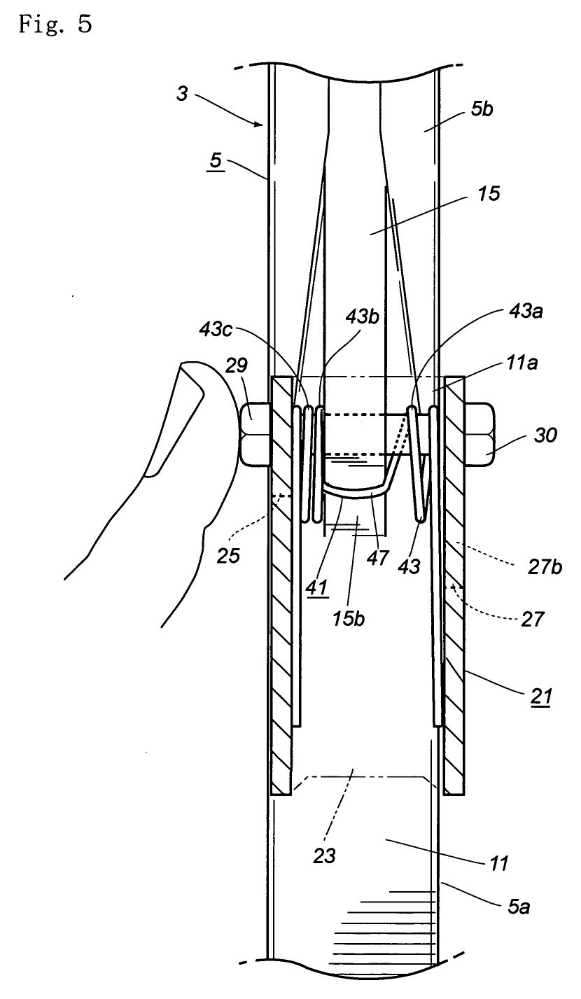

### i) The First Embodiment

[A. Construction (see FIGS. 1-5)]In the following detailed description of the first embodiment, reference is made to FIG. 1 in which the direction to the left and lower side of FIG. 1 is that to the front side of the rope hook, the direction to the upper side of the drawing is that to the upper side of the rope hook, and the direction to the left and upper side of the drawing is that to the left side of the rope hook. This definition can also be applied to the second embodiment.

The rope hook 1 of the present invention comprises a body 3 including a pair of hook shaped rope catches 7, 7′ and a pair of off-the-hook limiting levers 21, 21′ and complex springs 41 to urge the levers.

[A-1. The Body]

The body 3 is of generally substantially S shaped configuration, and includes a main frame 5, substantially J shaped upper and lower hook portions 7, 7′ extending in opposite direction from each end of the main frame respectively, and a pair of lever supports 15. The body is formed in one piece by forging. The tip 7a of the lower hook 7 is positioned in front of and below the intermediate portion 5c of the main frame 5, and the tip 7′a of the upper hook 7′ is positioned in rear of and above the intermediate portion 5c of the main frame 5.

Thus an opening 9 (see FIG. 1) for catching the rope is formed between the tip 7a of the lower hook 7 and the intermediate portion 5c (in which the lever support 15 is to be provided as mentioned below) of the main frame 5, and another opening 91 (see FIG. 1) for catching the rope is formed between the tip 7′a of the upper hook 7′ and the intermediate portion 5c (in which the lever support 15′ is to be provided as mentioned below) of the main frame 5.

The portion of the hooks 7, 7′ extending in parallel with the main frame 5 are tapered to their tips 7a, 7′a and curved outwardly from the frame 5.

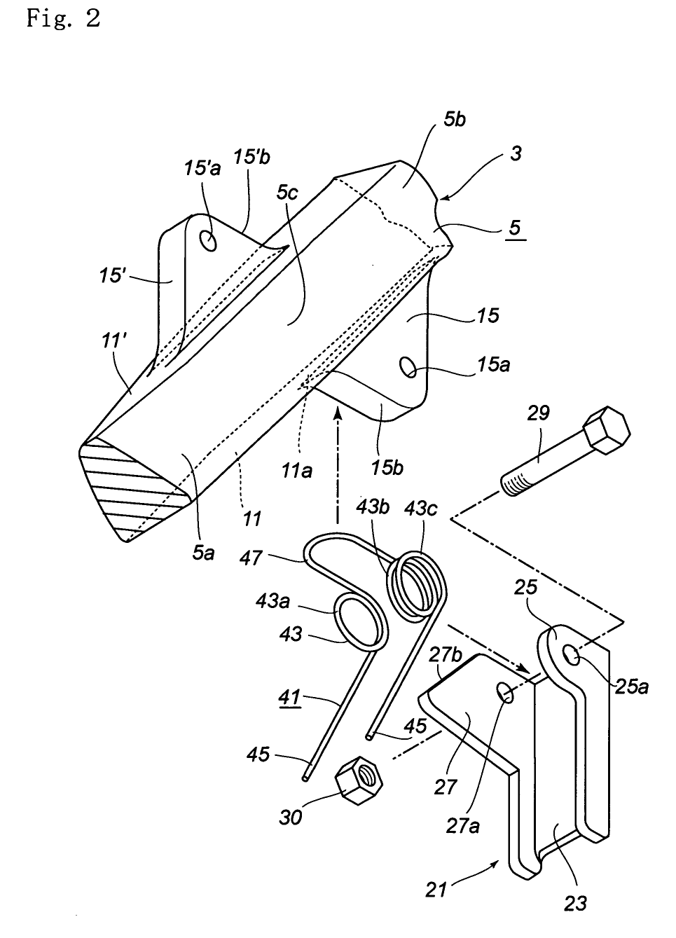

The cross-sectional shape of the intermediate portion 5c of the main frame 5 is of substantially rectangular larger in its front-rear direction. The cross-sectional shape of the main frame is varied therefrom to the lower and upper portions 5a, 5b to be substantially isosceles triangular or trapezoidal configuration. The rear side surface of the lower portion 5a is gradually narrowed toward the lower end to form a substantially ridgeline configuration (see FIG. 2), and then lead to the lower hook portion 7. As with the lower one, the front side surface of the upper portion 5b is also narrowed to the upper end and then lead to the upper hook portion 7′.

The upper side of thus formed front side surface 11 of the frame 5 is broad enough in its width to provide a front lever support 15 extending vertically therefrom. Similarly, the lower side of thus formed rear side surface 11′ of the frame 5 is also broad enough in its width to provide a rear lever support 15′ extending vertically therefrom.

The lever supports 15, 15′ are, when locked them laterally, formed as planer plates of right-angled triangular configuration. The thickness of each support is substantially one-third of the maximum width of the side surface of the main frame 5. The supports 15, 15′ are connected integrally to the frame 5 on their hypotenuse and extend therefrom with remaining a pair of opposite shoulders with respect to the side surfaces 11, 11′. The outer most protruding portion of each support or the vertical angle of the right-angled triangle is provided with a hole 15a, 15′a for receiving a pin (see FIG. 2).

In the rope hook 1, the shoulder defined on the side surface 11 at the right side of the support 15 is adapted to be used as a stopper surface 11a for the off-the-hook limiting lever 21. Similarly, the shoulder defined on the side surface 11′ at the left side of the support 15′ is adapted to be used as a stopper surface 11′a for the lever 21′.

The width W (see FIG. 1) of each opening 9, 9′ is defined between the apex of each support 15, 15′ and each tip 7a, 7′a of each hook 7, 7′.

[A-2. The Off-the-Hook Limiting Lever]

As can be seen from FIG. 1, the off-the-hook limiting levers 21 and 21′ are formed point-symmetrically and substantially identical in their structure and function. Thus, the description on the front off-the-hook limiting levers 21 can be applied equally to the rear lever 21′ so that no description are made with respect to the rear lever 21′.

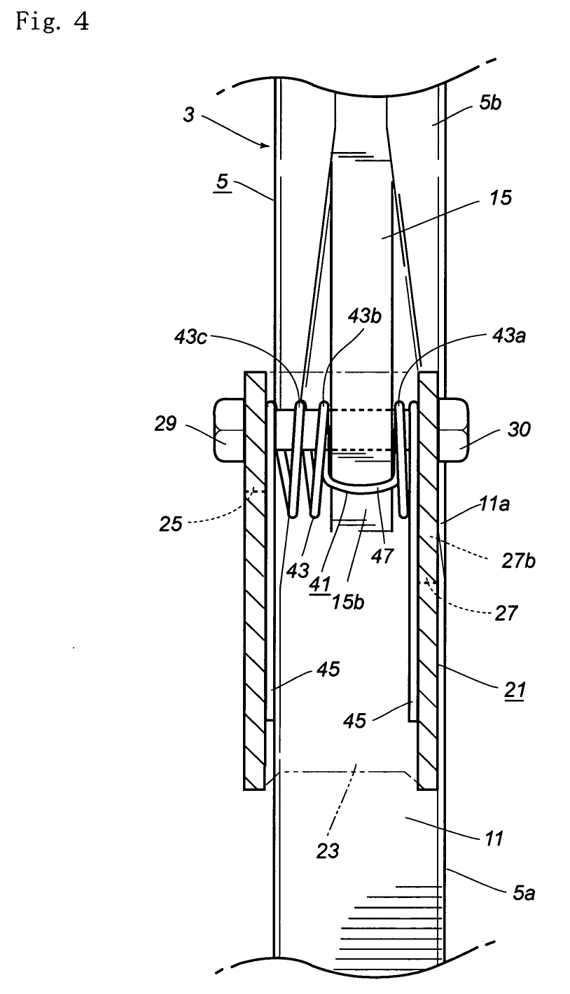

The off-the-hook limiting lever 21 is made of a relatively thick steel plate including a substantially planer rectangular base 23, and shorter and longer arms 25 and 27 extending vertically rearward from left and right edges of the base respectively. The length of the base 23 is substantially three-second of the width W of the opening 9. The spacing between arms 25 and 27 is substantially five-second of the thickness of the support 15 (see FIG. 4).

As can be seen from FIG. 2, a semicircular protrusion is provided on the upper end portion of the left arm 25. A circular through bore 25a for receiving a pin is provided through the center thereof. A trapezoidal protrusion is provided on the upper end to the middle part of the right arm 27. A through bore 27a for receiving a pin is provided therethrough in alignment with the bore 25a. The rear end edge of the trapezoidal protrusion is slanted to the rear-lower direction with respect to the base 23 to form a stopper edge 27b.

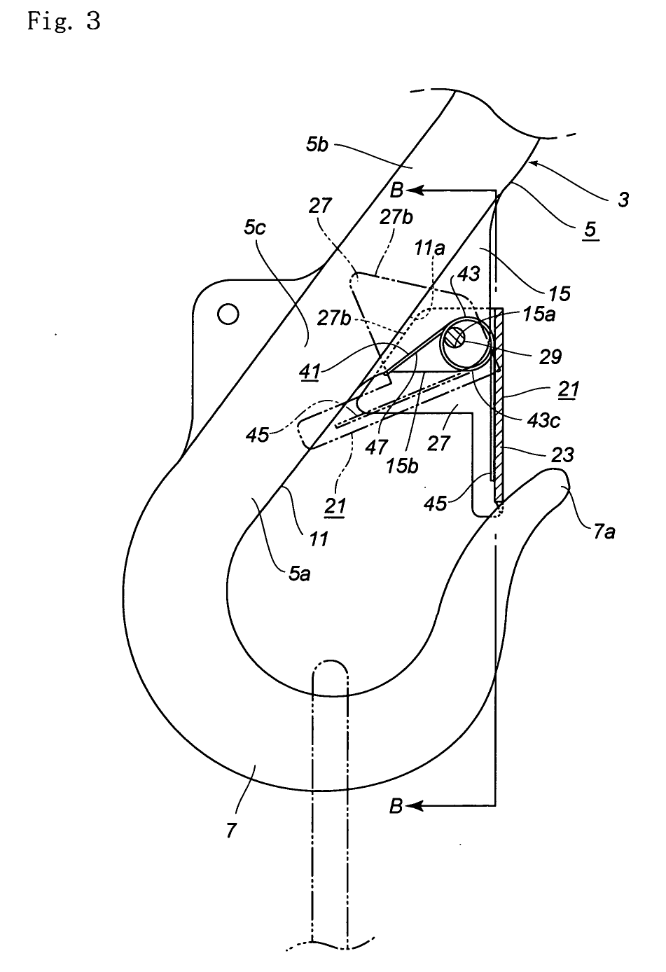

The off-the-hook limiting lever 21 is adapted to be straddled over the lever support 15 and attached pivotally thereto by means of a support pin 29. In the designated embodiment, the pin 29 is a bolt (see FIG. 2) extending through the bores 25a, 15a, and 27a, and secured by the nut 30 engaged therewith. In other words, the lever 21 is supported so as to swing in the front to rear direction by means of the support 15 through the pin 29. The lever can be pivoted from the closed position illustrated by the solid line in FIG. 3 in which the lower end of the base 23 contacts with the inner surface of the opening 9 to close it, and the opened position illustrated by the two-dot chain line in the same figure in which the lower end of the base 23 contacts with the front side surface 11 of the opening 9 to fully open the opening.

As described hereinabove, the spacing between arms 25 and 27 is five-second of the thickness of the lever support 15 so that the off-the-hook limiting lever 21 can be shifted laterally with respect to the support.

[A-3. The Complex Spring]

The complex spring 41 employed in the present invention includes a coil spring portion 43 and side arms 45 extending tangentially from the coil spring portion. The spring is made of one wire rod of spring material. As can be seen from FIG. 2, the coil 43 includes three loop sections and an intermediate arm 47. The winding direction of the right loop 43a is reversed to that of the left loops 43b, 43c. The loops 43b and 43a are connected with each other by means of the U shaped intermediate arm 47 interposed therebetween.

Thus, elastic force or energy sufficient to urge the side arms 45 and the intermediate arm 47 away from each other can be obtained.

The width of the intermediate arm 47 is slightly larger than the thickness of the lever support 15.

When assembling the off-the-hook limiting lever 21 to the lever support 15 by means of support pin 29 with interposing the complex spring 41 therebetween, the side arms 45 and the intermediate arm 47 are urged to slightly deform the coil loops. That is, upon assembling the lever 21 to the support 15, the coil spring portion 43 of the complex spring 41 is compressed slightly between the arms 25 and 27 so as to align the circles defined by each coil with the bores 25a and 27a, the side arms 45 are urged to the base 23, and then insert the support pin 29 to complete the assembly. In this condition, the fold portion of the U shaped intermediate arm 47 is disposed on the lower side edge of the support 15, and accordingly, the side arms 45 and the U shaped intermediate arm 47 are urged to the bottom edge of the support 15.

Thus the complex spring 41 is retained between the lever 21 with the coil spring portion 43 being supported by the pin 29, and the base 23 of the lever 21 is urged forwardly to the hook 7 to close the opening. This condition can be maintained unless the lever 21 is urged against the spring force, since the lever 21 is constantly urged in a clockwise direction.

With respect to the coil 43 of the complex spring 41, the right loop 43a is interposed between the right arm 27 and the support 15, and the remaining loops 43b and 43c are interposed between the left arm 25 and the support 15 in the length as it were or slightly compressed state as shown in FIG. 4.

In this connection, the lever 21 is adapted to be kept in its lock position in which the lever is offset leftward with respect to the support 15, unless the lever 21 is urged rightward to compress the loops 43b and 43c. In this lock position, the stopper edge 27b of the right arm 27 is presented in front of the stopper surface 11a.

The structure of the rope hook 1 of the present invention is as mentioned hereinabove.

[B. The Function of the Off-The-Hook Limiting Lever (see FIGS. 3-5)]

The function of the off-the-hook limiting lever 21 will now be described with reference to the attached drawings.

As can be seen from the above, the lever is adapted to be kept in its locked position unless the lever is urged rightward since the stopper edge 27b of the right arm 27 is presented in front of the stopper surface 11a. Thus, in this state, the lever 21 can be prevented from pivoting even if the lever 21 is pushed rearward since the lever 21 can be prevented from pivoting by bearing the stopper edge 27b against the stopper surface 11a, so that the opening 9 can not be opened even if the rope or so retained in the hook is loosened and the lever 21 is urged by thus loosened ropes bear against the front side of the lever.

Whereas, if the lever 21 is urged rightward to compress the loops 43b and 43c of the coil to disengage the arm 27 of the lever from the stopper surface 11a, and then the opening 9 can be opened by pushing the lever 21 rearward to pivot it toward the open position.

As can be seen from the above, the pivoting of the lever to the opening direction can be achieved only when the urging force toward the rightward direction and the pushing force toward rearward direction perpendicular to the direction of the urging force are applied to the lever sequentially. The application of two forces sequentially to the lever cannot normally be occurred unless the forces are applied intentionally. Thus, an accident of unexpected opening of the lever 21 due to the application of unforeseen forces can surely be avoided substantially.

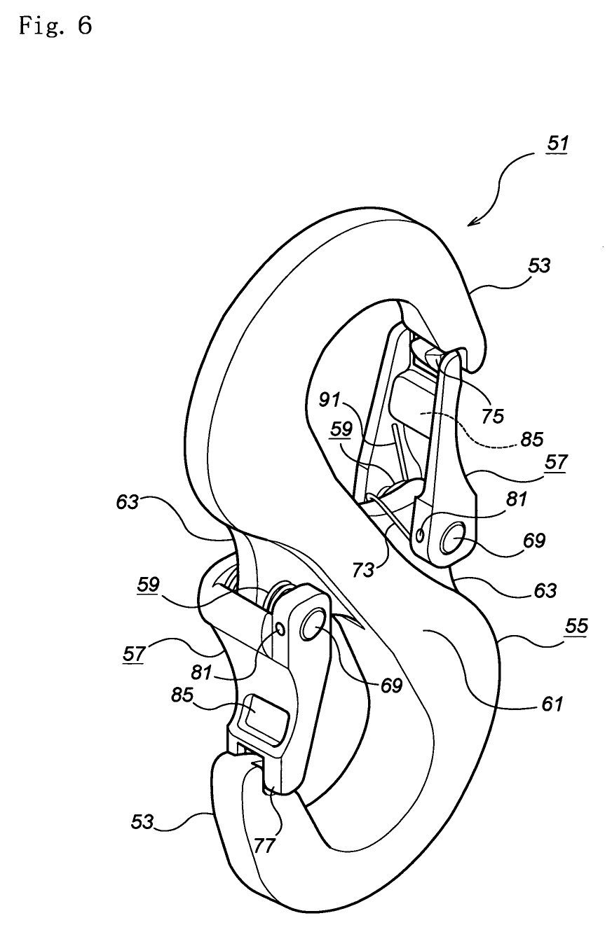

### ii) The Second Embodiment

[A. Construction (see FIGS. 6-9)]

The rope hook of the second embodiment of the present invention is substantially equal to that of the first embodiment described with reference to FIGS. 1-5 so that the descriptions on the common features of these embodiments are set forth in summary, and the differences therebetween will now be described in detail.

The rope hook 51 is generally S shaped and includes a body 55 and a pair of hook shaped rope catches 53 provided at both ends of the body. A pair of off-the-hook limiting levers 57 are pivotally connected to the body 55. The levers are urged constantly by means of complex springs 59 toward the locked condition.

Each one of the hook portions 53, the levers 57, and the springs 59 are described with reference the drawings, since each one of these elements are formed point-symmetrically.

[A-1. The Body]

The body 55 includes an intermediate portion 61 the upper and lower ends of which are provided with a pair of loop shaped hook portions 53 of substantially trapezoidal cross-section. These hook portions are formed integrally with the intermediate portion 61 and extend in opposite directions.

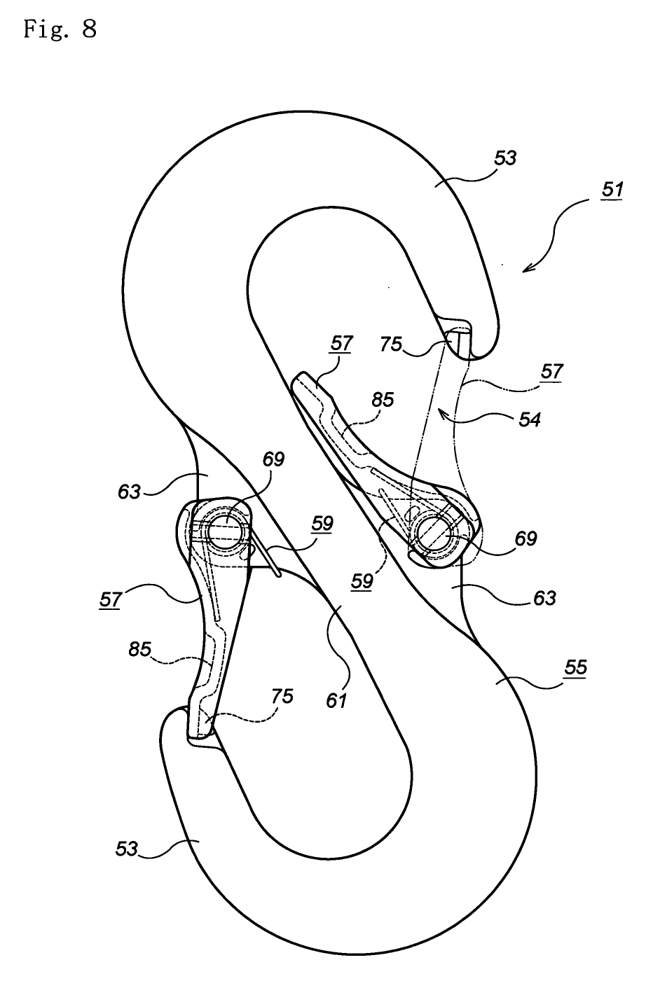

As can be seen from FIG. 8, a pair of lever supports 63 for mounting the off-the-hook limiting levers 57 are provided on left and right sides of the intermediate portion 61.

A pair of guide ribs 67 of different length are provided on each lever support 63 to hold outer periphery of a coil 65 of a complex spring 59. The support is further provided with a through bore 71 for inserting the support pin 69. The pin is a shaft around which the lever can be pivoted. An intermediate arm 73 of the spring 59 is adapted to be rest on the surface of the support facing the hook portion 53.

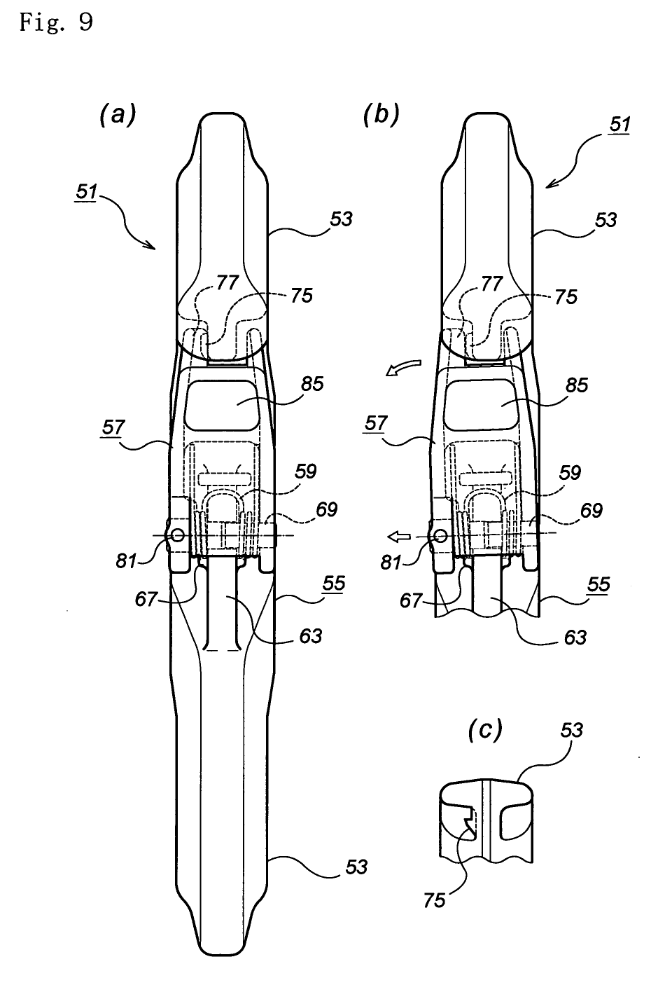

The tip of the hook portion 53 is formed as a mushroom shape by grinding the both sides thereof as shown in FIG. 9(c). A locking claw 75 of substantially triangular cross-sectional configuration is formed on one of the sides of the thin part remained unground on the tip of the hook.

The locking claw 75 is adapted to be engaged with a locking protrusion 77 formed on an inner side edge of one of the legs defining a notch through the tip portion of the lever 57. The tapered side surface of the claw 75 presents a guide surface for the locking protrusion 77 upon engaging the lever 57 therewith.

[A-2. The Off-the-Hook Limiting Lever]

The off-the-hook limiting lever 57 is made of a channel shaped member having a maximum width in its proximal portion. The width of the lever is narrowed or tapered to the tip or distal portion thereof.

Through bores 79a, 79b for receiving a supporting pin 69 are provided through the upper portion of the legs of the lever. The right bore 79a is larger in its diameter than that of the left one so as to accommodate the support pin 69.

The thickness of the left leg of the lever is greater than that of the right one since provided therethrough is a bore 83 for receiving the securing pin 81 to prevent the withdrawal of the support pin 69.

The lever 57 is provided at its tip portion with a rectangular notch. The inside surface of one of the legs defining the notch is provided with a locking protrusion 77 to which the locking claw 75 of the hook portion is to be urged.

The front surface of the tip of the lever 57 is further provided with a recessed finger rest 85 used in urging the lever to open the opening.

[A-3. The Support Pin]

The support pin 69 is a stepped member including a maximum diameter

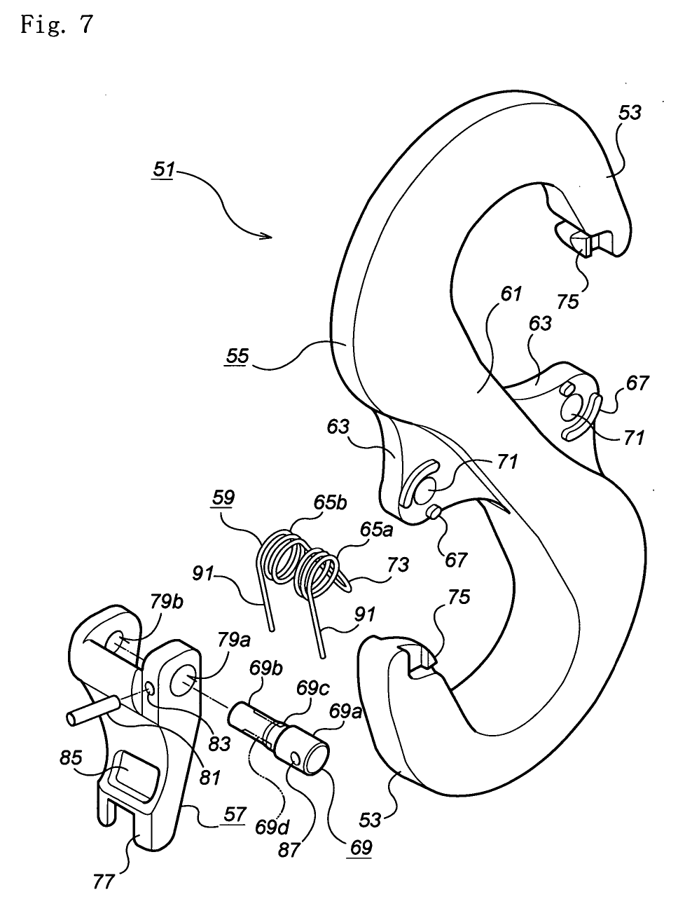

portion 69a, a minimum diameter portion 69b, and an intermediate diameter portion 69c as shown in FIG. 7.

The enlarged portion 69a is provided with a through bore 87 extending perpendicular to the axis of the support pin for receiving the securing pin 81. The bore 87 is adapted to be aligned with the bore 83 upon assembling the support lever to the rope hook in order to receive the pin 81.

The reduced diameter portion 69b is adapted to be fit with the through bore 79b of the lever 57. A portion proximal to the reduced diameter portion 69b is formed to provide a little margin or offset between the pin 69 and the lever support 63 upon pivoting the lever 57 as mentioned hereinbelow.

The offset can be enlarged by reducing the diameter of the reduced diameter portion 69b to form a further reduced diameter portion 69d as shown by the phantom line in FIG. 7.

The intermediate portion 69c is adapted to be fit with the through bore 71 of the lever support 63 so that the lever 57 can be pivoted therearound from the closed position (i.e. the locked position) to the opened position.

[A-4. The Complex Spring]

The complex spring 59 of this embodiment is substantially similar to the spring 41 of the first embodiment, i.e. the spring 59 is served as a torsion coil spring as well as a compression coil spring.

The complex spring 59 is made of one wire rod of spring material. As can be seen from FIG. 7, the spring includes a closely coiled portion 65a, a U shaped intermediate arm 73, a roughly coiled portion 65b and a pair of side arms 91 extending from the portions 65a and 65b.

The lateral displacement of the lever 57 with respect to the support can be allowed by the spacing provided by the roughly coiled portion 65b.

The complex spring 59 is adapted to be held by means of a pair of guide ribs 67 on the lateral surface of the lever support 63 so as to be coaxial with the support pin 69. In such a condition, the loop formed by the intermediate arm 73 bears against the bottom surface of the lever support 53, and the side arms 91 are urged against the rear surface of the lever 57 near the finger rest 85.

[B. The Function of the Off-the-Hook Limiting Lever (see FIGS. 8 and 9)]

The function of the off-the-hook limiting lever 57 will now be described.

In the normal position or locked position shown in FIG. 9, the locking protrusion 77 of the lever 57 is engaged with the locking claw 75 of the hook portion 53 so that the opening 54 is closed.

In this condition, the intermediate portion 69c of the support pin 69 fits in the through bore 71 of the lever support 63 without leaving any margin. The lateral movement of the lever is thus restrained.

Even if the rope strikes the lever because of its unintentional and unexpected movement, the lever 57 is kept unmoved to maintain its closed position (locked position).

When it is intended to remove the rope, the lever 57 is pushed leftward to present the portion of the support pin 69 proximal to the minimum diameter portion 69b thereof against the inner surface of the through bore 71 of the lever support 63 to provide a little margin for swing the lever to disengage the locking protrusion 77 with the locking claw 75 as shown in FIG. 9(b).

Then the operator pulls the tip of the lever 57 to swing it leftward by his finger engaged with the finger rest 85 so as to disengage the locking protrusion 77 with the locking claw 75. The lever 57 can thus be pivoted rearward to shift it to its open position so that the opening 54 of the hook portion 53 can be opened.

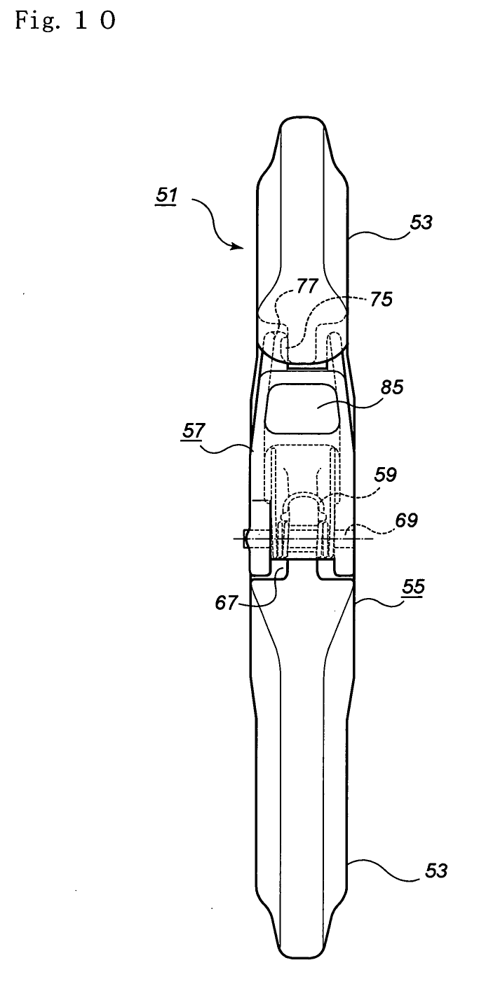

### iii) The Third Embodiment (see FIGS. 10-13)

The rope hook 90 of the third embodiment of the present invention is elementarily similar to the rope hook 51 of the second embodiment, so that the descriptions on the common features of these embodiments are omitted, and only the differences therebetween will now be described. In the following description, the same reference numerals as those employed in the descriptions on the second embodiment are added to the elements substantially identical with corresponding elements of the second embodiment.

[A. The Complex Spring]

The complex spring 93 is served as a torsion coil spring as well as a compression coil spring.

The spring 93 is made of one wire rod of spring material. The spring includes a coil 97a, an U shaped intermediate arm 95, a coil 97b and a pair of side arms 99. The coils are substantially identical in this winding fashion.

[B-1. The Lever Support]

The structure of the body 92 is substantially identical with the body 55 of the rope hook 51 except for the lever support 101. The lever support 101 leans rightward at 3° at its intermediate portion in the drawings. The coils 97a and 97b of the complex spring 93 are urged at their inner side portions 97c and 97d against the coil compressing means or leaned portions 101a, 101b of the support. Further, the base of the support 101 is larger in its dimension relative to the intermediate portion thereof.

The inner diameter of the bore 103 provided through the support 101 for threading the support pin 105 is larger than the outer diameter of the pin to leave some margin therebetween. Thus the off-the-hook limiting lever 57 can swing around the pivotal fulcrum formed by the pin 105 and the bore 103.

The inside surface 57a and 57b of the legs of the lever 57 to which the outer side portions 97e and 97f of the coil 97a and 97b are urged are not leaned in the drawings. Each of the inside surfaces 57a and 57b are faced with the leaned portions 101a, 101b of the support 101 respectively.

[B-2. The Function of the Off-the-Hook Limiting Lever]

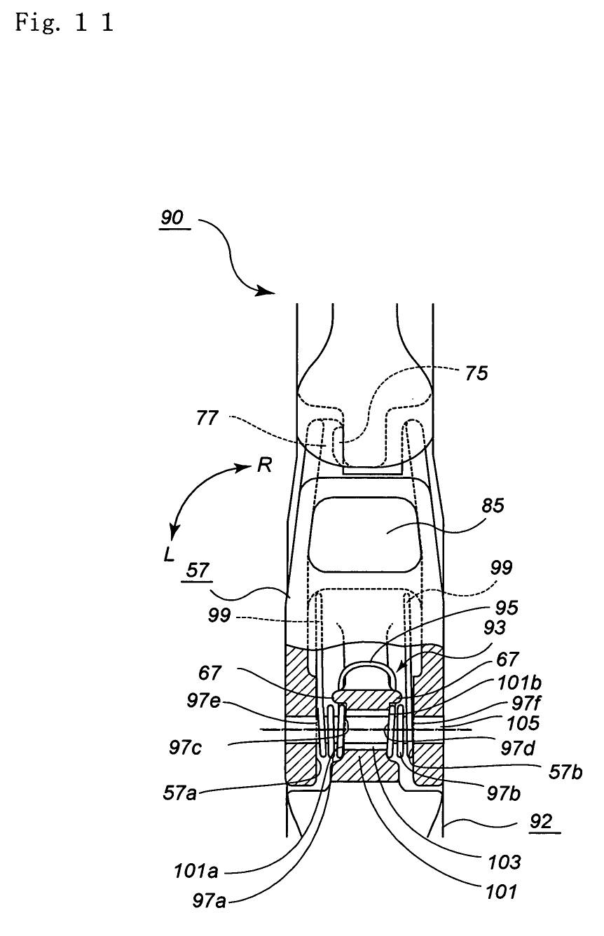

The coils 97a and 97b of the complex spring 93 are urged at their inner side portions 97c and 97d against the leaned portions 101a, 101b of the support, and urged at their outer side portions 97e and 97f against the inside surface 57a and 57b of the lever, so that the lower portion of the coil 97a is substantially compressed relative to the upper portion thereof, whereas the upper portion of the coil 97b is substantially compressed relative to the lower portion thereof as shown in the attached drawings. Thus the lever 57 is urged in clockwise direction (referred to as “R-direction” hereinbelow) due to the spring forces obtained by the compressed portions of the coils. In other words, the lever 57 is urged by means of the coils 97a and 97b to the locked position (see FIGS. 10 and 11). Thus the lever 57 is pivoted in the R-direction together with the support pin 105 within the range defined by the margin between the pin 105 and the bore 103, and kept in its locked position.

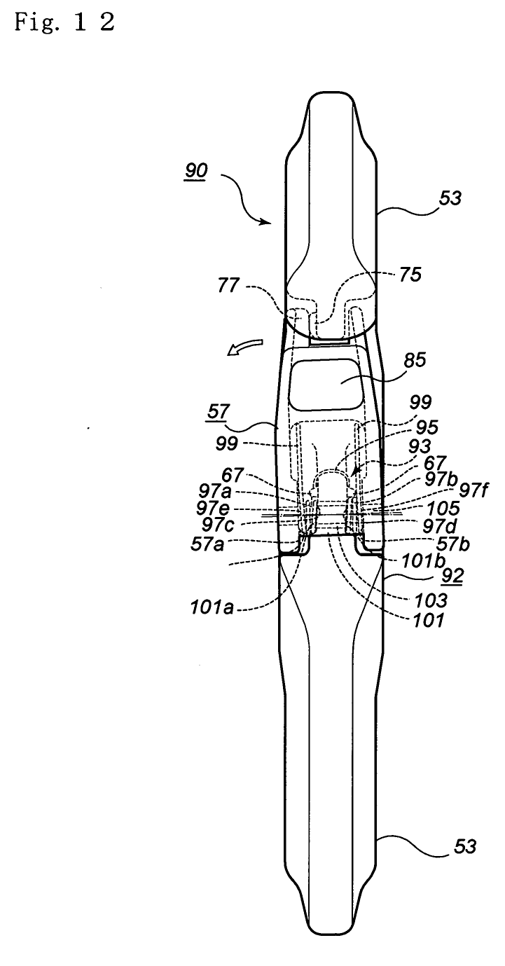

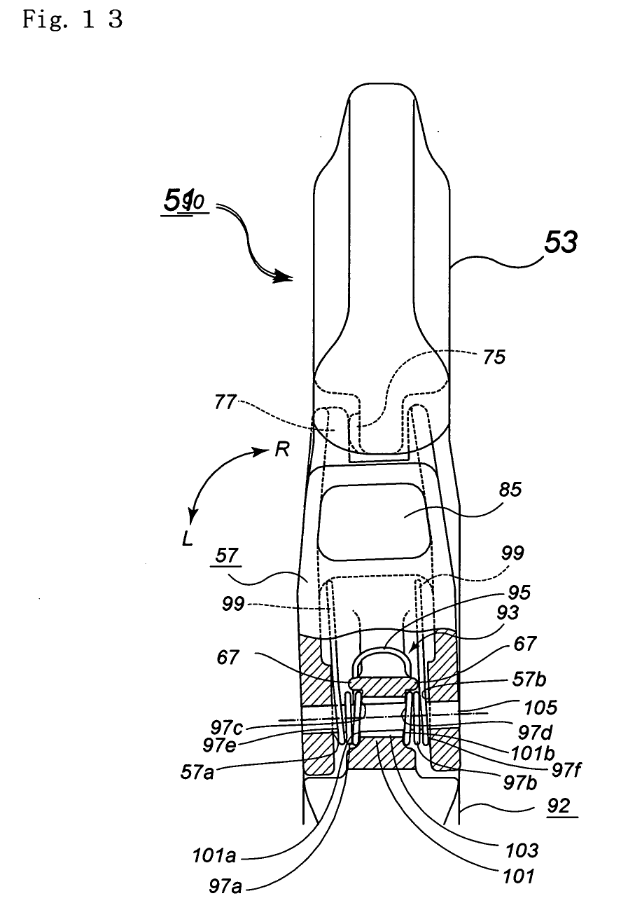

When it is intended to release the lever 57 to open the opening 54 of the hook 53 for putting off the rope, the lever is pushed in a counterclockwise direction (referred to as “L-direction” hereinbelow) against the urging force of the coils 97a and 97b as shown in FIGS. 12 and 13 to disengage the locking claw 75 from the locking protrusion 77. Then the lever is pivoted rearward to displace it to the open position and the opening 54 of the hook is opened.

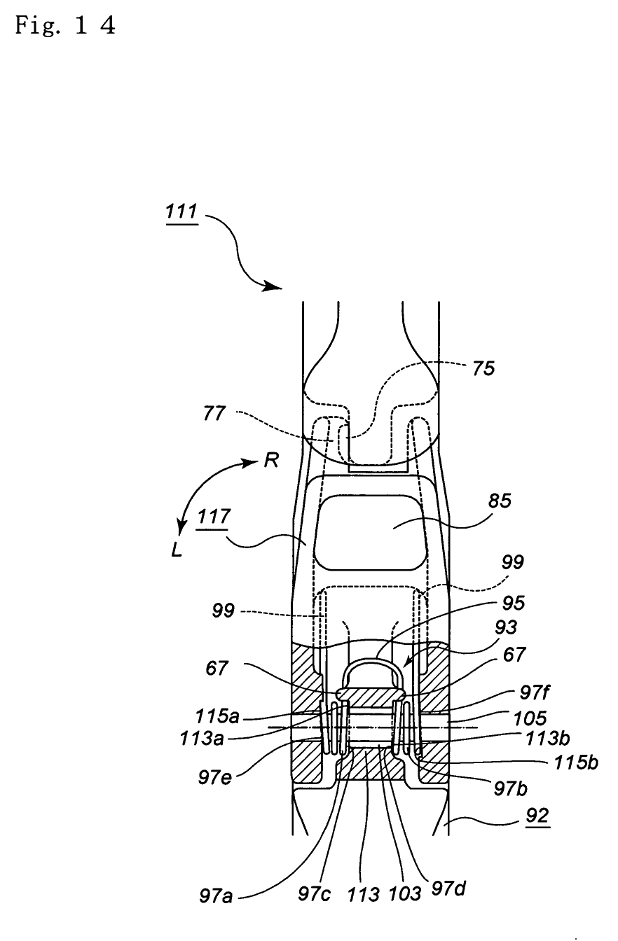

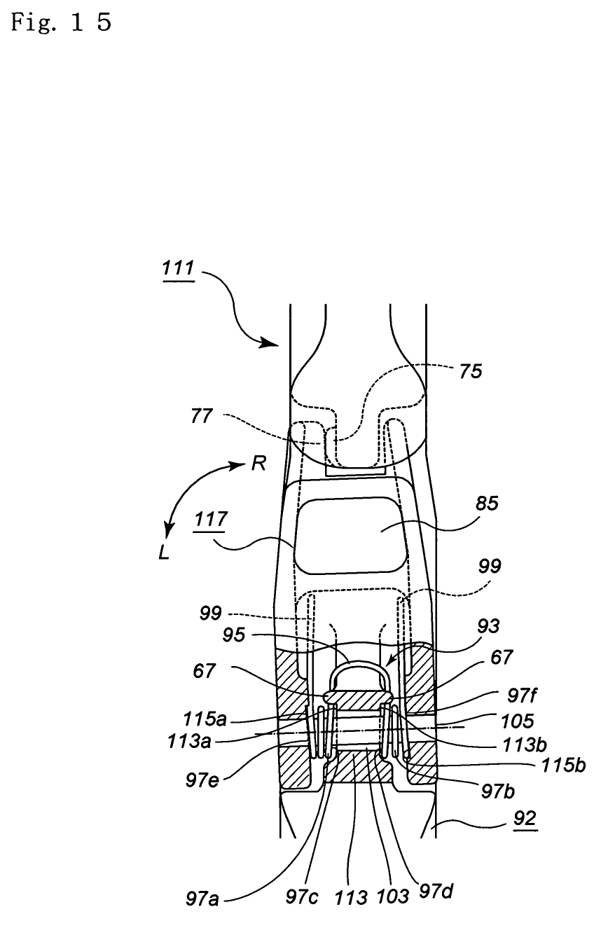

### iv) The Fourth Embodiment (see FIGS. 14 and 15)

The rope hook 111 of the fourth embodiment of the present invention is elementarily similar to the rope hook 51 of the second embodiment or the rope hook 90 of the third embodiment, so that the descriptions on the common features of these embodiments are omitted, and only the differences therebetween will now be described. In the following description, the same reference numerals as those employed in the descriptions on the rope hook 51 of the second embodiment and the rope hook 90 of the third embodiment are added to the elements substantially identical with corresponding elements of the second or third embodiment.

The intermediate portion of the lever support 113 of the rope hook 111 extends straightforward from the rope hook of this embodiment, and the side surfaces 113a, 113b of the intermediate portion of the support 113 are also extend straightforward to define vertical surfaces.

The inside surfaces of the legs of the lever 117 are provided with inclined surfaces 115a and 115b leaned at 3° leftward. The coils 97a and 97b of the complex spring 97 are adapted to be urged against the surfaces 115a and 115b at their outer side surface 97e and 97f respectively, and urged against the side surfaces 113a, 113b at their inner side surfaces 97c and 97d respectively. Thus the lever 117 is normally urged in R-direction to the locked position by means of the coils 97a and 97b. The lever 105 is pivoted in R-direction under the allowance of the margin defined between the pin 105 and the bore 103 (see FIG. 14).

When it is intended to put off the rope, the lever 57 is urged in L-direction as shown in FIG. 15 against the spring forces provided by the coils 97a and 97b to disengage the locking claw 75 from the locking protrusion 77. Then the lever 57 is pushed into the opening 54 to open the hook 53.

While particular embodiments of the present invention have been illustrated and described, it should be obvious to those skilled in the art that various changes and modifications can be made without departing from the spirit and scope of the invention.

For example, in the first embodiment of the invention, although the stopper means for preventing the pivoting of the off-the-hook lever toward its open position is provided by the side surface of the body, any stopper means such as the other suitable portion of the rope hook can be used or any special stopper means can be provided therefor.

Although the present invention have been applied to the rope hook in the first and second embodiments, the present invention can be applied broadly to the other retaining means including a hook shaped retainer such as shackle, carabiner, turnbuckle, or so. Of course, the present invention can also be applied to the retaining means with swiveling function.

The inclination of the portions 101a, 101b of the support of the third embodiment and the surfaces 115a and 115b of the fourth embodiment are defined hereinabove as 3°. However, the inclination can be varied in accordance with any factor such as the length of the lever.

Although the inside surfaces 57a and 57b of the legs of the lever 57 of the rope hook 90 were defined to be extend vertically in the third embodiment, and the side surfaces 113a and 113b of the legs of the lever 113 of the rope hook 111 were defined to be extend vertically in the fourth embodiment, the surfaces 57a and 57b, and 113a and 113b can be inclined in the reverse direction relative to those of the leaned portions 101a, 101b, inclined surfaces 115a and 115b, as long as the lever 57 can be pivoted in R-direction by means of the coils 97a and 97b.

### INDUSTRIAL APPLICABILITY

The rope hook of the present invention can not be opened unless two forces perpendicular with each other are applied sequentially to the off-the-hook lever as described hereinabove.

The lever can remained locked to close the opening of the rope catch of the rope hook of the present invention, unless the lever is shifted laterally by applying a force in the one direction to release it from locked condition and the lever is then pivoted in the other direction perpendicular to the one direction, or the lever swings laterally to release the locked condition and the lever is then pivoted toward the body of the rope hook. Thus the remarkably superior rope hook good at its safety can be provided. The rope hook can also be manipulated easily.

In the embodiment in which the lever swings to release the locked condition, the lock can be released easier than the embodiment in which the lever is shifted laterally, and the space required for shifting the lever laterally can be reduced.

1-13. (canceled)

14. A rope hook comprising:
a body including a pair of substantially hook shaped rope catches;
an off-the-hook limiting lever pivotally connected at its base by a pivotal fulcrum to the body of a part other than a tip portion of the rope catch so as to pivot from a closed position in which an end portion of the lever bears against an inside surface of the tip to close an opening defined between the end portion and the tip to an open position in which the end portion is spaced from the tip;
a spring configured to urge the lever to pivot to a closed position;
a spring configured to provide clearances allowing lateral displacement of the lever in a direction perpendicular to the pivotal movement of the lever within a predetermined range and to urge the lever laterally to their locked position; and
stopper means for preventing the pivotal movement of the lever toward one open position only when the off-the-hook limiting levers are positioned in their locked position.

15. The rope hook according to claim 14, wherein the stopper means includes a surface portion of the body defined beside a lever support to which the lever is to be pivotally connected at its base and a portion of the base of the lever.

16. The rope hook according to claim 14, wherein the stopper means includes a locking claw formed on the tip of the rope catch and a locking protrusion formed on the end portion of the lever.

17. The rope hook according to claim 16, wherein a predetermined amount of clearance or margin allowing lateral swing of the lever to disengage the locking protrusion with the locking claw is provided at the pivotal fulcrum of the lever.

18. The rope hook according to claim 14, wherein the spring configured to urge the lever to the closed position and the spring configured to urge the lever to its locked position are combined to form an integral spring.

19. The rope hook according to claim 18, wherein the integral spring includes coils and side arms extending from an end of each coils and is a complex spring made of one wire rod of spring material, the arms are configured to urge the lever toward the closed position, and the coils are configured to urge the lever to the locked position.

20. A rope hook comprising:
a body including a pair of substantially hook shaped rope catches;
an off-the-hook limiting lever pivotally connected at its base by a pivotal fulcrum to the body of a part other than a tip portion of the rope catch so as to pivot from a closed position in which end portions of the lever bear against an inside surface of the tip to close an opening defined between the end portion and the tip to an open position in which the end portions are spaced from the tips;
a spring configured to urge the lever to pivot it to the closed position;
a spring configured to provide clearances allowing displacement of the lever in a direction perpendicular to the pivotal movement of the lever within a predetermined range and to urge the lever laterally to its locked position; and
stopper means configured to prevent the pivotal movement of the lever toward the open position only when the off-the-hook limiting levers are positioned in their locked position.

21. The rope hook according to claim 20, wherein the stopper means includes a locking claw formed on the tip of the rope catch and a locking protrusion formed on the end portion of the lever.

22. The rope hook according to claim 21, wherein a predetermined amount of clearance or margin allowing swing of the lever to disengage the locking protrusion with the locking claw is provided at the pivotal fulcrum of the lever.

23. The rope hook according to claim 20, wherein the spring configured to urge the lever to the closed position and the spring configured to urge the lever to its locked position are combined to form an integral spring.

24. The rope hook according to claim 23, wherein the integral spring includes coils and side arms extending from an end of each coil and is a complex spring made of one wire rod of spring material, the arms are configured to urge the lever toward the closed position and the coils are configured to urge the lever to the locked position.

25. The rope hook according to claim 24, further comprising means for compressing the coil of the spring to urge the lever to the locked position.

26. The rope hook according to claim 25, wherein which the means for compressing the coil is formed by an inclined portion provided in either of the body or the lever to which the coils are urged.
